(19) United States
(12) Patent Application Publication
(10) Pub. No.: US 2006/0043786 A1
(43) Pub. Date: Mar. 2, 2006

(54) Rear hub assembly for a bicycle

(75) Inventor: King-Chen Lin, Ta-Liao Hsiang (TW)

Correspondence Address: NIKOLAI & MERSEREAU, P.A., 900 SECOND AVENUE SOUTH, SUITE 820, MINNEAPOLIS, MN, 55402, US

(73) Assignee: Chin Haur Industry Co., Ltd., Ta-Liao Hsiang (TW)

(21) Appl. No.: 10/924,523

(22) Filed: Aug. 24, 2004

(51) Int. Cl. B60B 27/00

(52) U.S. Cl. 301/110.5

(57) ABSTRACT

A rear hub assembly for a bicycle has a hub with two flanges. A recess is defined in one of the flanges. Two bearings are installed in the hub. A sleeve is fastened between and coaxial with the bearings by two collars. A hub spline has a ratchet engaged in the recess of the hub. An axle extends through the hub spline and the hub. The axle has a first cover provided at a first end of the axle. A first ring recess is defined at a second end of the axle. A second cover is secured on the second end of the axle. An O-ring is provided in the second cover and positioned in the ring recess. Whereby, the hub, hub spline, and axle can be easily and quickly assembled together without a tool.

### BACKGROUND OF THE INVENTION

1. Field of the Invention

The present invention relates to a rear hub assembly for a bicycle, and more particularly to a rear hub which can be easily and manually assembled.

2. Description of Related Art

In a bicycle, a rear hub assembly generally includes an axle extending through a hub spline and a hub and secured on a rear fork of the bicycle. A ratchet is provided between the hub spline and the hub. A chain wheel is provided outside the hub spline and driven by a chain. When the chain wheel is rotated forwards, the hub is driven and when the chain wheel is rotated backwards, the hub is not driven.

However, in a conventional rear hub assembly, the axle is rotatably fastened to the hub and hub spline by nuts after being extended through the hub and hub spline, so it is very inconvenient to assemble the rear hub assembly and a tool must be used.

Therefore, the invention provides a rear hub assembly for a bicycle to mitigate or obviate the aforementioned problems.

### SUMMARY OF THE INVENTION

The main objective of the present invention is to provide a rear hub assembly which can be easily and manually assembled without a tool.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a rear hub assembly for a bicycle in accordance with the present invention;

FIG. 2 is a cross sectional view of the rear hub assembly in FIG. 1; and

FIG. 3 is a side view of the rear hub assembly in FIG. 1.

### DETAILED DESCRIPTION OF THE PREFERRED EMBODIMENT

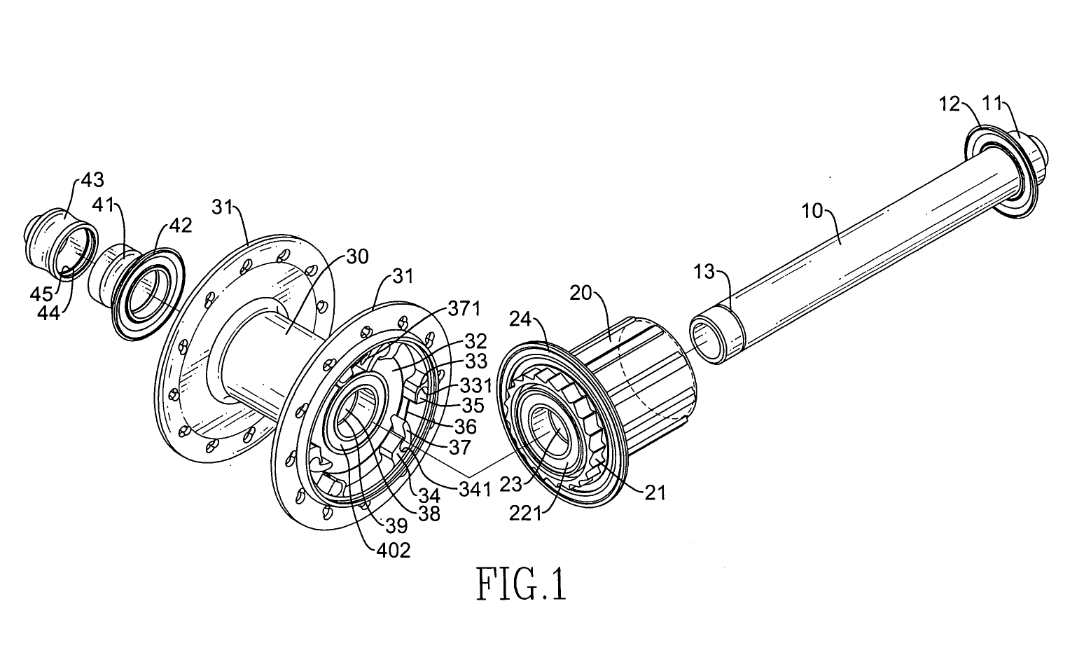

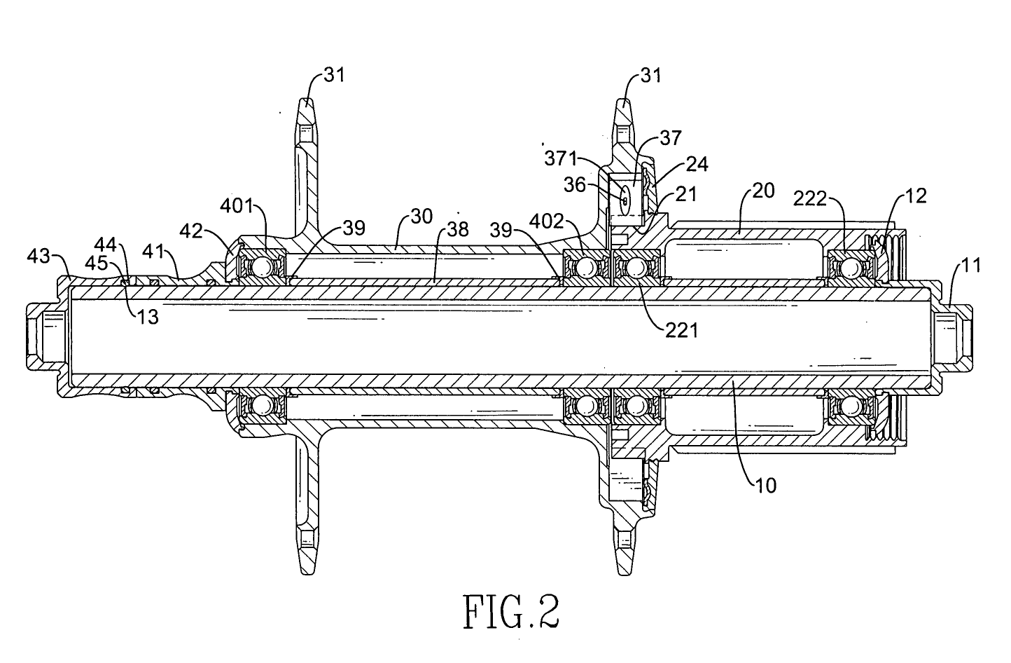

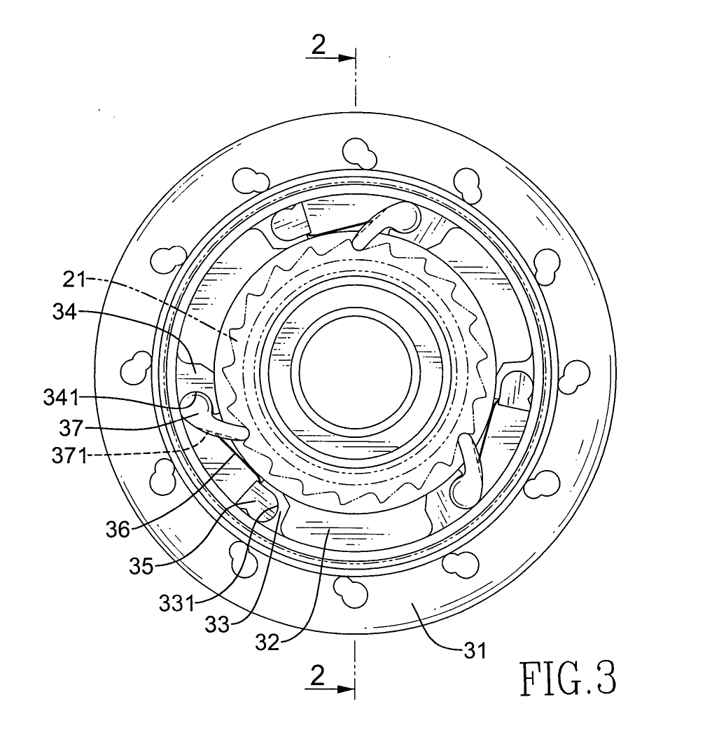

With reference to FIGS. 1-3, a rear hub assembly for a bicycle in accordance with the present invention is composed of a hub (30), a hub spline (20) and an axle (10).

The hub (30) has two flanges (31) respectively formed at two sides thereof. A recess (32) is defined in one of the flanges (31). A first bearing (401) and a second bearing (402) are mounted in the hub (30) and a first sleeve (38) is received in the hub (30) and between the bearings (401, 402). Two collars (39) are respectively mounted at two ends of the sleeve (38) to secure the sleeve (38) with the bearings (401, 402) coaxially.

The hub spline (20) has a ratchet (21) received and uni-directionally rotatable in the recess (32) of the hub (30). A third bearing (221) and fourth bearing (222) are mounted in the hub spline (20). A second sleeve (23) is received in the hub spline (20) and between the third and fourth bearings (221, 222). A flange (24) is formed beside the ratchet (21) to enclose the recess (32) when the ratchet (21) is received in the recess (32).

The axle (10) extends through the hub spline (20) and the hub (30) and is fastened on a rear fork of the bicycle (not shown). The engagement between the axle (10) and the rear fork is the same as a conventional structure known by those skilled in the art and will not be described in detail. A first end cover (11) is provided on a first end of the axle (10) and extends out from the hub spline (20). A first cap (12) made of rubber is provided outside the first end cover (11) to shield the fourth bearing (222) from dirt, water etc. A first ring recess (13) is defined at a second end of the axle (10) and extends out from the hub (30). A second cap (41) with a rubber ring (42) is provided on the axle (10) and between the ring recess (13) and the hub (30). A second end cover (43) is mounted on the second end of the axle (10). A second ring recess (44) is defined in an inner wall of the second end cover (43) for receiving an O-ring (45) therein. The O-ring (45) is made of rubber and has an inner diameter slightly larger than an outer diameter of the axle (10). In assembling the second cover (43), the O-ring (45) is expanded slightly outwards to enlarge the inner diameter thereof and then be eased over the axle (10). When the O-ring (45) arrives at the first ring recess (13), the inner diameter of the O-ring (45) contracts to be positioned in the first ring recess (13). Therefore, the axle (10) is securely mounted in the hub (30), the hub spline (20).

For disassembling the axle (10), the second cover (43) is pulled out and the O-ring (45) is expanded again to enable the second cover (43) to be removed from the axle (10).

Multiple teeth (34) and multiple stops (33) are alternately formed on an inner circumference of the recess (32), e.g. one tooth (34) is provided between two adjacent stops (33), and one stop (33) is provided between two adjacent teeth (34). The teeth (34) each have a first slot (341) defined at a side thereof facing one of the adjacent stops (33), and the stops (33) each have a second stop (331) defined at a side thereof facing the corresponding first stop (341). Multiple fingers (37) are respectively rotatably received in the first slot (341) of the teeth (34) and engaged with the ratchet (21). The fingers (37) each have a groove (371) defined at a back surface thereof. Multiple blocks (35) are respectively received in the second slots (331). Multiple resilient wires (36) are respectively secured on the blocks (35) and each have a free end extending towards the corresponding finger (37) and positioned in the corresponding groove (371).

When the ratchet (21) is rotated counter-clockwise, the fingers (37) can be pivoted in the respective first slots (341) to allow the rotation of the ratchet (21). Under the elastic force of the resilient wires (36), the fingers (37) tightly abut the ratchet (21) to prevent the ratchet (21) from clockwise rotation. Therefore, the ratchet (21) can be rotated in the recess (32) in only one direction.

Those skilled in the art will understand that the stop (33) and block (35) can alternatively be replaced with a screw (not shown) installed in the recess (32) for securing the resilient wire (36).

Therefore, a chain wheel (not shown) is mounted on the hub spline (20) for driving the ratchet (21) and the fingers (37). When the chain wheel is turned forwards, the hub (30) is rotated; when the chain wheel is turned backwards, the hub (30) is free running because the fingers (37) are pressed outwards.

According to the present invention, because the axle (10) is inserted through the hub spline (20) and the hub (30) and the cover can be directly secured by the O-ring (45), the rear hub assembly can be manually and quickly assembled or disassembled without using a tool.

Because the multiple fingers (37) are provided, the engagement between the ratchet (21) and the fingers (37) can be ensured even if one or more fingers (37) experiences failure.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A rear hub assembly for a bicycle comprising:
a hub (30) having two flanges (31) respectively formed at two sides of the hub (30), a recess (32) defined in one of the flange (31), a first bearing (401) and a second bearing (402) installed in the hub (30), a first sleeve (38) fastened between and coaxial with the first and second bearings (401, 402) by two collars (39) respectively at two ends of the first sleeve (38);
a hub spline (20) having a ratchet (21) formed at a side facing the hub (30) and engaged in the recess (32), a third bearing (221) and a fourth bearing (222) installed in the hub spline (20), and a second sleeve (23) fastened between the third and fourth bearings (221, 222); and
an axle (10) extending through the hub spline (20) and the hub (30), the axle (10) having a first cover (11) provided at a first end of the axle, a first ring recess (13) defined at a second end of the axle, a second cover (43) secured on the second end of the axle, and an O-ring (45) provided in the second cover (43) and positioned in the ring recess (13).

2. The rear hub assembly as claimed in claim 1, wherein the second cover (43) has a second ring recess (44) defined in an inner wall of the second cover (43), and the O-ring (45) is positioned in the second ring recess (44) and has an inner diameter slightly larger than an inner diameter of the second cover (43).

3. The rear hub assembly as claimed in claim 1, wherein the hub (30) has multiple teeth (34) and multiple stops (33) alternately formed on an inner circumference of the recess (32), multiple fingers (37) respectively rotatably mounted on the teeth (34) and engaged with the ratchet (21), and multiple resilient wires (36) respectively provided on the stops (33) and each having a free end abutting a back surface of a corresponding one of the fingers (37).

4. The hub assembly as claimed in claim 3, wherein the teeth (34) each have a first slot (341) defined at a side facing one of the adjacent stops (33), the stops (33) each have a second slot (331) defined at a side facing the corresponding first stop (341), the fingers (37) are respectively rotatably received in the first slots (341) of the teeth (34), the blocks (35) are respectively received in the second slots (331), and the resilient wires (36) respectively secured on the blocks (35).

5. The hub assembly as claimed in claim 4, wherein the fingers (37) each have a groove (371) defined at the back surface, and the free ends of the resilient wires (36) are respectively positioned in the grooves (371).
